(19) United States
(12) Patent Application Publication
(10) Pub. No.: US 2004/0088364 A1
(43) Pub. Date: May 6, 2004

(54) Apparatus and method for controlling electronic devices

(75) Inventor: Shinji Yamadaji, Tachikawa-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/668,244

(22) Filed: Sep. 24, 2003

(30) Foreign Application Priority Data
Oct. 30, 2002 (JP) 2002-315912

(51) Int. Cl. G06F 15/16

(52) U.S. Cl. 709/208

(57) ABSTRACT

A control apparatus controls first and second electronic devices. The control apparatus includes a unit which assigns first and second electronic mail addresses to the first and second electronic devices, respectively, a receiving unit which receives an electronic mail via a network, the electronic mail including one of the first and second electronic mail addresses as a destination address, a unit which selects an electronic device to be controlled from the first and second electronic devices in accordance with the destination address of the received electronic mail, and a unit which controls an operation of the selected electronic device in response to an instruction described in the received electronic mail.

### CROSS-REFERENCE TO RELATED APPLICATIONS

This application is based upon and claims the benefit of priority from the prior Japanese Patent Application No. 2002-315912, filed Oct. 30, 2002, the entire contents of which are incorporated herein by reference.

### BACKGROUND OF THE INVENTION

1. Field of the Invention

The present invention relates to an apparatus for controlling a plurality of electronic devices connected to, for example, a home network and a method for doing the same.

2. Description of the Related Art

A video programming system for programming a video recorder away from home has recently been developed.

U.S. Pat. No. 6,374,406 discloses a receiving apparatus for receiving an electronic mail (e-mail) and programming a video deck based on the electronic mail. The receiving apparatus extracts a control command added to the electronic mail and controls the video deck in accordance with the control command.

A home network for controlling various home electronic devices such as video equipment, audio equipment and an air conditioner is developed as information processing technology and network technology progress. The home network requires a method for selectively remote-controlling various home electronic devices away from home. In order to remotely control the home electronic devices using e-mail, a message to designate a target device to be controlled needs to be described in the body of the e-mail in a predetermined specific format.

It is however difficult for a number of users to store a specific format correctly and compose a message in this format correctly. The users therefore desire to implement a method capable of selectively remote-controlling a plurality of home electronic devices in the home network away from home by simple and intuitive operations for the users.

### BRIEF SUMMARY OF THE INVENTION

According to an embodiment of the present invention, there is provided a control apparatus which controls first and second electronic devices, comprising means for assigning first and second electronic mail addresses to the first and second electronic devices, respectively, a receiving unit which receives an electronic mail via a network, the electronic mail including one of the first and second electronic mail addresses as a destination address, means for selecting one of the first and second electronic devices in accordance with the destination address of the received electronic mail, and means for controlling an operation of the selected electronic device based on an instruction described in the received electronic mail.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a home network system according to an embodiment of the present invention.

FIG. 2 is a block diagram of a home network server provided in the home network system shown in FIG. 1.

FIG. 3 is a table showing an example of mail address information managed by the home network server shown in FIG. 2.

FIG. 4 is a table showing an example of access control information managed by the home network server shown in FIG. 2.

FIG. 5 is a flowchart showing a mail address assigning process performed by the home network server shown in FIG. 2.

FIG. 6 is a flowchart showing an access control information setting process performed by the home network server shown in FIG. 2.

FIG. 7 is a flowchart showing a device control process performed by the home network server shown in FIG. 2.

FIG. 8 is a first view of the transmission/reception of email between the home network server shown in FIG. 2 and a portable terminal.

FIG. 9 is a second view of the transmission/reception of email between the home network server shown in FIG. 2 and a portable terminal.

FIG. 10 is a flowchart showing an example of a process performed when the home network server shown in FIG. 2 receives an email with no body.

FIG. 11 a third view of the transmission/reception of email between the home network server shown in FIG. 2 and a portable terminal.

FIG. 12 is a table showing an example of command definition information managed by the home network server shown in FIG. 2.

FIG. 13 a fourth view of the transmission/reception of email between the home network server shown in FIG. 2 and a portable terminal.

FIG. 14 a fifth view of the transmission/reception of email between the home network server shown in FIG. 2 and a portable terminal.

FIG. 15 a sixth view of the transmission/reception of email between the home network server shown in FIG. 2 and a portable terminal.

FIG. 16 a seventh view of the transmission/reception of email between the home network server shown in FIG. 2 and a portable terminal.

FIG. 17 is a table showing an example of execution history information managed by the home network server shown in FIG. 2.

### DETAILED DESCRIPTION OF THE INVENTION

An embodiment of the present invention will now be described with reference to the accompanying drawings.

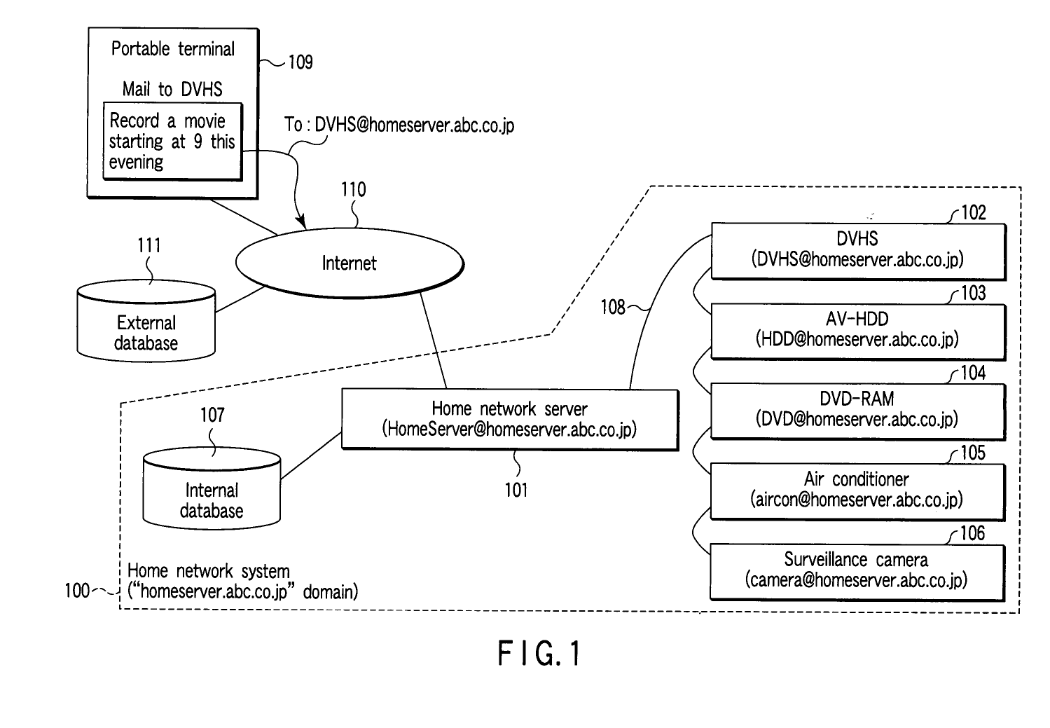

FIG. 1 shows a home network system 100 according to an embodiment of the present invention. The home network system 100 uses a home network server (or simply referred to as a home server) 101. The home network server 101 is a control apparatus for controlling the operations of various electronic devices connected to a home network 108. The home network server 101 is connected to an external network such as the Internet 110 and the home network 108.

The home network 108 is implemented using, e.g., an IEEE 1394 serial bus or a wired or wireless LAN. The home network server 101 carries out communications with the electronic devices, which are connected to the home network 108, via the home network 108. In the present embodiment, a digital VHS video recorder (DVHS) 102, a hard disk audio video recorder (AV-HDD) 103, a DVD-RAM drive 104, an air conditioner 105 and a surveillance camera 106 are connected to the home network 108.

The DVHS 102 is an electronic device serving as a digital videocassette recorder (VCR). The AV-HDD 103 is an electronic device capable of recording audio/video (AV) data in a hard disk drive (HDD). The DVD-RAM drive 104 is an electronic device that drives DVD-RAM media to record AV data on the DVD-RAM media and reproduce AV data therefrom.

The air conditioner 105 is an air-conditioning electronic device for cooling and heating air. The surveillance camera 106 is an electronic device which monitors the appearance of the front door of the home, the park or the like, in which the camera 106 is set up.

An electronic mail (e-mail) address is assigned to each of the home network server 101, DVHS 102, AV-HDD 103, DVD-RAM drive 104, air conditioner 105 and surveillance camera 106. The home network server 101 can operate as a mail server. The assignment of e-mail addresses to the electronic devices is performed by the home network server 101. The following are examples of the email addresses assigned to the devices:

Home network server: HomeServer@homeserver.abc.co.jp

DVHS: DVHS@homeserver.abc.co.jp

AV-HDD: HDD@homeserver.abc.co.jp

DVD-RAM: DVD@homeserver.abc.co.jp

Air conditioner: aircon@homeserver.abc.co.jp

Surveillance camera: camera@homeserver.abc.co.jp

Each of the e-mail addresses is made up of a domain name to the right of the @ sign and a username to the left of the @ sign. “homeserver.abc.co.jp” is the domain name of the home network system 100. The username of each e-mail address is information for identifying an electronic device in the home network system 100 and indicates the name of the electronic device.

The home network server 101 receives an e-mail including the domain name “homeserver.abc.co.jp” as a destination address from the Internet 110. The home network server 101 determines an electronic device to be controlled from the username included in the destination address of the received e-mail. Then, the server 101 controls the electronic device based on an instruction described in the received e-mail.

A user can remotely control an electronic device in the home network system 100 away from home. The user operates a portable terminal 109 such as a mobile phone and a PDA to create an e-mail and send it to an electronic device to be controlled through the Internet 110. The destination address of the e-mail is an e-mail address assigned to the electronic device to be controlled.

If the DVHS 102 is an electronic device to be controlled, the destination address of e-mail sent from the portable terminal 109 is “DVHS@homeserver.abc.co.jp”. The body of the e-mail contains a message composed by a user. The message is used as an instruction for indicating an operation to be performed by the electronic device to be controlled.

The e-mail that is sent from the portable terminal 109 is transmitted to the home network server 101 via the Internet 110. The server 101 receives the e-mail and selects a device to be controlled in accordance with the destination address of the received e-mail. If the destination address of the e-mail is “DVHS@homeserver.abc.co.jp”, the home network server 101 determines the DVHS 102 as an electronic device to be controlled.

The home network server 101 controls the electronic device, which is designated by the destination address of the received e-mail, in accordance with the instruction provided in the received e-mail. In this case, the home network server 101 converts the instruction into a command interpreted by the electronic device to be controlled and sends the command to the electronic device via the home network 108. If the sent command is one for making a request to acquire the current status of the electronic device to be controlled, the home network server 101 creates an e-mail including a message corresponding to the status returned from the electronic device and sends the e-mail back to the portable terminal 109.

If the instruction described in the received e-mail is ambiguous, in order to generate a command to be sent to the electronic device to be controlled, the home network server 101 first analyzes the message in the received e-mail and extracts a keyword available to give an instruction to the electronic device from the message. Then, the server 101 searches an internal database 107 or an external database 111 using the extracted keyword and generates a command to be sent to the electronic device based on the result of the search.

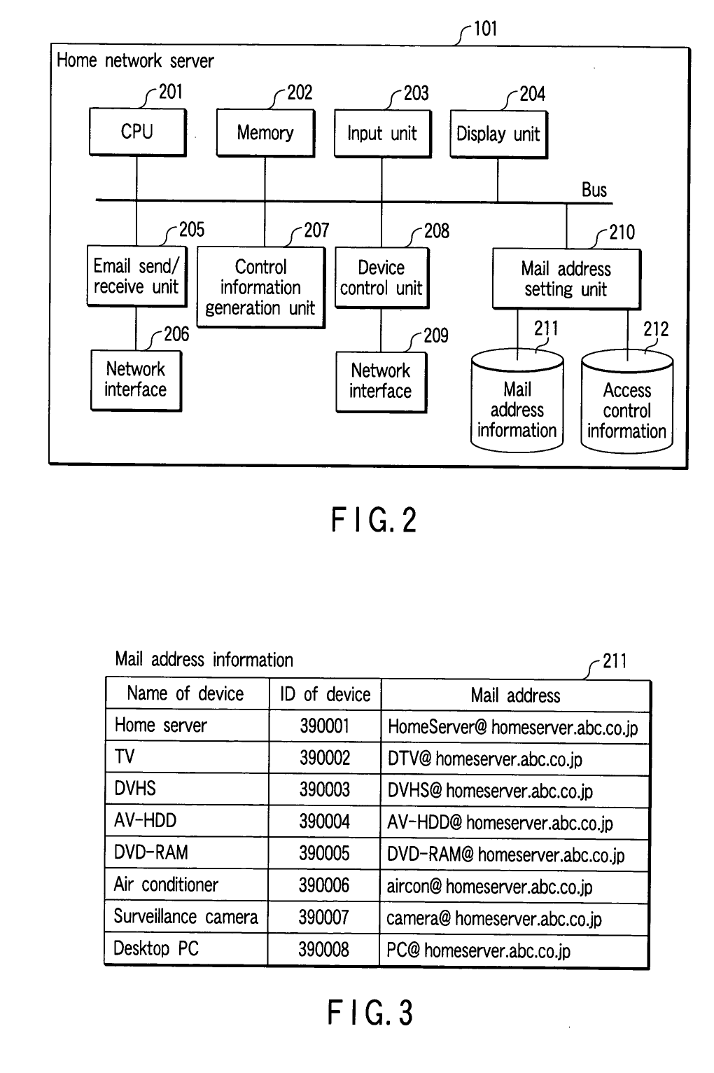

The configuration of the home network server 101 will now be described with reference to FIG. 2.

The home network server 101 includes a CPU 201, a memory 202, an input unit 203, a display unit 204, an e-mail send/receive unit 205, a network interface 206 for Internet connection, a control information generation unit 207, a device control unit 208, a network interface 209 for home network connection, a mail address setting unit 210, a mail address information storage unit 211 and an access control information storage unit 212, as illustrated in FIG. 2.

The CPU 201 is a processor that controls an operation of the home network server 101. The CPU 201 executes programs stored in the memory 202 to assign an e-mail address to each of electronic devices, control a target electronic device in accordance with the received e-mail, and the like.

The input unit 203 is an input device operable by a user, such as a keyboard and a mouse. The display unit 204 is formed of a display monitor such as an LCD. These units 203 and 204 are used to implement a GUI (graphical user interface).

The e-mail send/receive unit 205 is connected to the Internet 110 via the network interface 206. The unit 205 receives an e-mail via the Internet 110 and returns an e-mail to the sender of the received e-mail via the Internet 110.

The control information generation unit 207 generates a command (including parameters) for controlling a target electronic device based on an instruction described in the e-mail received by the e-mail send/receive unit 205.

The device control unit 208 is connected to the home network 108 through the net work interface 209 to control the respective electronic devices connected to the home network 108. The device control unit 208 sends the command generated by the control information generation unit 207 to an electronic device to be controlled via the home network 108. The electronic device is designated by the destination address of the e-mail received by the e-mail send/receive unit 205.

The mail address setting unit 210 assigns an e-mail address to each of the electronic devices connected to the home network 108. The e-mail address of each of the electronic devices is managed by the mail address setting unit 210 as mail address information. The mail address information is stored in the mail address information storage unit 211. FIG. 3 shows an example of the mail address information.

As shown in FIG. 3, the mail address information represents the name, ID and e-mail address of each of the electronic devices in the home network system 100. The ID is information for uniquely identifying each of the electronic devices in the home network system 100. The e-mail addresses assigned to the electronic devices can be changed when the need arises. If, moreover, a new electronic device is added to the home network system 100, an e-mail address can be assigned to the new electronic device.

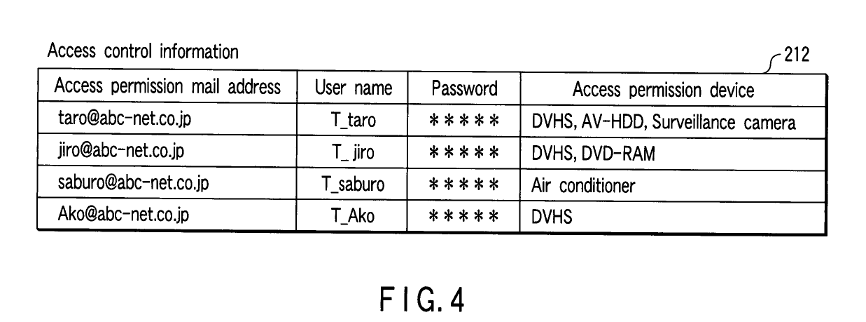

The mail address setting unit 210 has a function of generating and managing access control information. The access control information represents a relationship between an e-mail address of each user who can get access to the home network server 101 and an electronic device controllable by the user. The access control information is used to restrict an electronic device controllable by each of users who can use the home network system 100. The access control information is stored in the access control information storage unit 212. FIG. 4 shows an example of the access control information.

As shown in FIG. 4, the access control information represents a user's e-mail address, a username (full name, log-in name, etc.), a password, and the name of a controllable electronic device for each of users who can use the home network system 100.

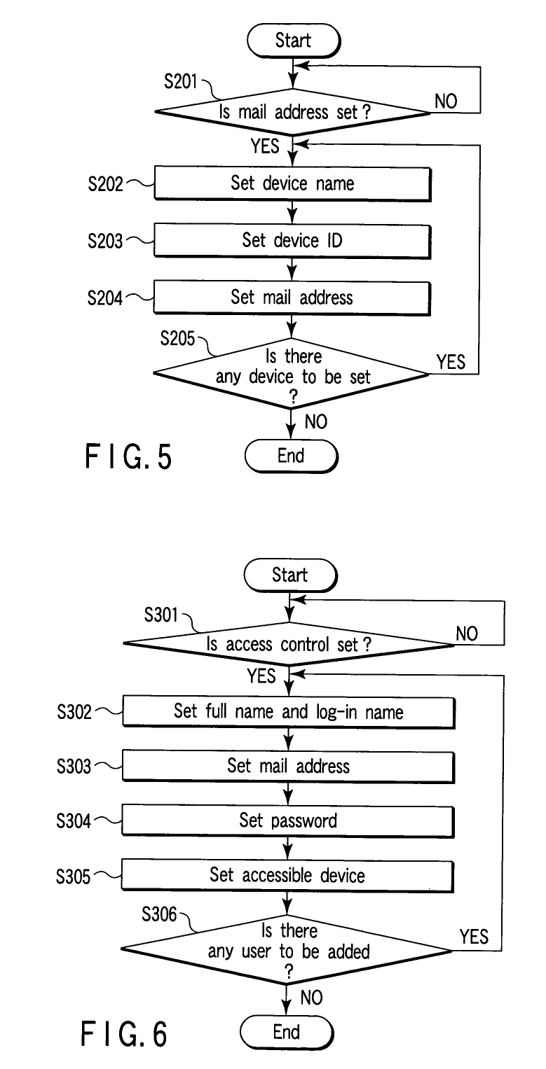

A process of assigning an e-mail address to each of electronic devices will now be described with reference to the flowchart shown in FIG. 5.

As described above, the assignment of e-mail addresses to the electronic devices connected to the home network 108 is performed by the mail address setting unit 210. When a user makes a request to set a mail address (YES in step S201), the mail address setting unit 210 sets the name, ID and e-mail address of each of the electronic devices to the mail address information in accordance with the input operation of the user (steps S202 to S205). The mail address setting unit 210 includes a GUI for setting a mail address. The user can designate the name, ID and e-mail address of each of the electronic devices using the GUI.

In step S202, the mail address setting unit 210 displays a device name setting screen on the display unit 204. The user can describe the maker name, model number, etc. of an electronic device to be controlled on the device name setting screen.

In step S203, the mail address setting unit 210 displays a device ID setting screen on the display unit 204. The user describes a TCP/IP address or a GUID (global unique ID), which is assigned to a target electronic device, as a device ID on the device ID setting screen. Any device ID can be used if the electronic device can uniquely be identified within the home network system 100.

In step S204, the mail address setting unit 210 displays a mail address setting screen on the display unit 204. The user describes an e-mail address to be assigned to a target electronic device on the mail address setting screen.

Mail address information is therefore generated. Using this mail address information, the home network server 101 can determine an electronic device to be controlled, by the destination address of the received e-mail.

A process of generating access control information will now be described with reference to the flowchart shown in FIG. 6.

As described above, the mail address setting unit 210 generates access control information. When an administrator user makes a request to set the access control information (YES in step S301), the mail address setting unit 210 sets a user name (full name, log-in name, etc.), a user's mail address, a password and an accessible electronic device for each of users who can get access to the home network 108 in accordance with the input operation of the administrator user (steps S302 to S306).

Access control information is therefore generated. Using this access control information, the home network server 101 can allow an electronic device designated by the destination address of the received e-mail to be controlled or inhibit it from being controlled, based on the source address (sender address) of the received e-mail.

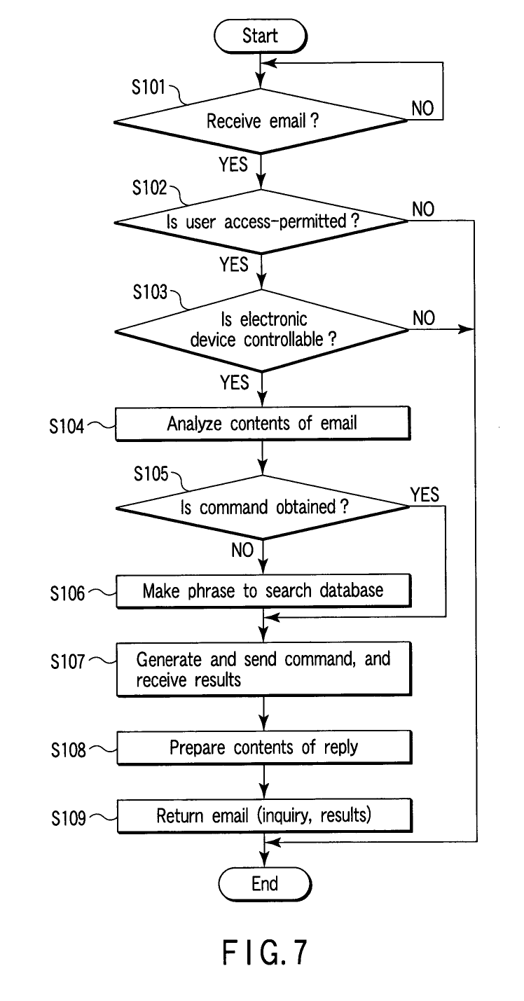

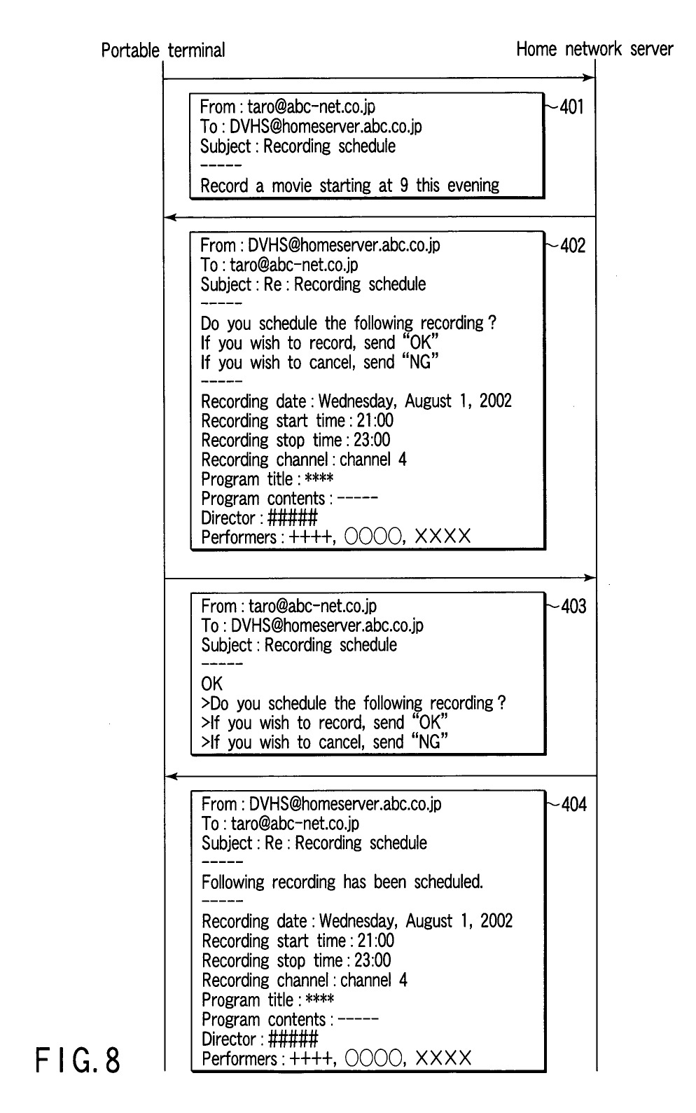

An explanation as to how an electronic device in the home network system 100 is remotely controlled will now be made with reference to FIGS. 7 and 8.

Assume that a user “taro” programs the DVHS 102 using the portable terminal 109 to perform a recording operation. FIG. 7 shows a process performed by the home network server 101, and FIG. 8 shows the transmission and reception of e-mail between the portable terminal 109 and home network server 101.

The user “taro” operates the portable terminal 109 to create an e-mail 401 as shown in FIG. 8. The body of the e-mail 401 has a message “Record a movie starting at 9 this evening”. The sender address of the e-mail 401 is “taro@abc-net.co.jp” and the destination address thereof is “DVHS@homeserver.abc.co.jp”. The e-mail 401 is sent to the Internet 110 from the portable terminal 109.

The home network server 101 receives the e-mail including the domain name “homeserver.abc.co.jp” as a destination address through the Internet 110 using the e-mail send/receive unit 205. Upon receiving the e-mail (YES in step S101), the home network server 101 determines whether to allow the control of an electronic device designated by the destination address based on the sender address and destination address included in the received e-mail and the access control information stored in the access control information storage unit 212 (steps S102 and S103).

More specifically, the home network server 101 first determines whether a user designated by the sender address “taro@abc-net.co.jp” of the e-mail 401 is a person with access permission who is registered in the access control information (step S102). If the user has access permission (YES in step S102), the home network server 101 determines whether an electronic device to which the destination address “DVHS@homeserver.abc.co.jp” of the e-mail 401 is assigned is one controllable by the user designated by the sender address “taro@abc-net.co.jp” (step S103). If the electronic device is controllable (YES in step S103), the home network server 101 performs the following process in order to control the electronic device to which the destination address “DVHS@homeserver.abc.co.jp” is assigned.

The home network server 101 analyzes the message in the body of the received e-mail 401 using the control information generation unit 207 and extracts a keyword from the message (step S104). When all information necessary for generating a command to be sent to an electronic device to be controlled (DVHS 102 in this case) is obtained by the extraction of the keyword, or when all information (e.g., recording date, recording start/stop time, recording channel and recording mode) necessary for programming the electronic device is obtained (YES in step S105), the home network server 101 advances to step S107.

On the other hand, when the instruction described in the e-mail, such as the above message “Record a movie starting at 9 this evening” is ambiguous, no information necessary for programming the electronic device to perform a recording operation can be obtained from the message. In this case (NO in step S105), the home network server 101 searches a program information database stored in the internal database 107 or the external database 111 on the basis of the keyword extracted in step S104 to acquire information necessary for programming the device (step S106).

The program information database is one item of EPG (electronic program guide) information and indicates broadcast date and time, a channel number and a program attribute (genre, title, contents, performers, director, etc.) for each broadcast program.

The home network server 101 extracts the following keywords from the message “Record a movie starting at 9 this evening”:

(1) Recording date: “Aug. 1, 2002” is extracted from the phrase “this evening” and the current date and time. The current date and time are provided by the calendar and clock function of the home network server 101.

(2) Recording start time: “21:00” is extracted from the phrase “at 9 this evening”.

(3) Recording channel: Program genre “movie” is extracted from the word “movie”.

If the program information database is searched based on the above extracted keywords, the following information is obtained:

(1) Recording date: Wednesday, Aug. 1, 2002

(2) Recording start time: 21:00

(3) Recording stop time: 23:00

(4) Recording channel: channel 4

(5) Program title: ****

(6) Program contents: - - -

(7) Director: ####

(8) Performers: ++++, oooo, xxxx

The recording channel indicates a channel number for a program to be recorded and the recording title indicates a title of the program. The recording contents correspond to a message showing the summary of the program.

By doing so, in step S106, the instructions given by the message in the e-mail 401 are predicted by the home network server 101.

Moreover, in step S106, the home network server 101 prepares a reply e-mail (402 in FIG. 8) with the message indicative of the predicted instructions and sends it to the sender address “taro@abc-net.co.jp” of the e-mail 401. The user “taro” can see the e-mail 402 to confirm the user's own instructions. Upon receiving an e-mail (403 in FIG. 8) with “OK” from the user “taro”, the home network server 101 advances to step S107.

In step S107, the home network server 101 generates a command to be sent to the DVHS 102 using the control information generation unit 207. Then, the home network server 101 sends the command to the DVHS 102 using the device control unit 208. The DVHS 102 performs a programming process in response to the command and returns performance result information, which indicates the contents of the performed programming process, to the home network server 101.

The home network server 101 prepares a reply e-mail (404 in FIG. 8) with a message including the performance result information from the DVHS 2 and sends it to the sender address “taro@abc-net.co.jp” (steps S108 and S109).

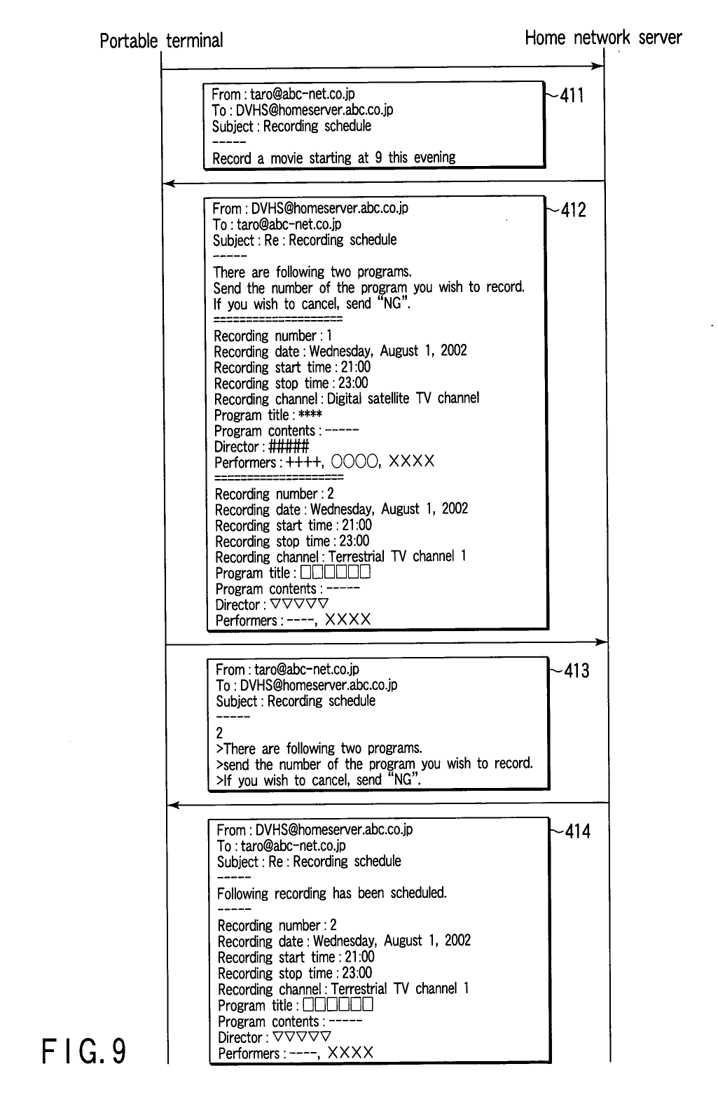

A second example of the process of the transmission/reception of e-mail between the portable terminal 109 and the home network server 101 will now be described with reference to FIG. 9. This example is directed to the case where the program information database is searched to predict two candidates for programs to be recorded.

The user “taro” operates the portable terminal 109 to create an e-mail 411 as shown in FIG. 9. The body of the e-mail 411 includes, for example, a message “Record a movie starting at 9 this evening”. The sender address of the e-mail 411 is “taro@abc-net.co.jp” and the destination address thereof is “DVHS@homeserver.abc.co.jp”.

Upon receiving the e-mail 411, the home network server 101 extracts a keyword from the message composed in the e-mail 411 and searches the program information database using the keyword. Assume that two programs (program “1” and program “2”) are predicted as ones to be recorded as a result of the search. The home network server 101 prepares a reply e-mail 412 as shown in FIG. 9 and sends it to the user “taro” in order to make the user “taro” select one of the two programs. The user “taro” sees the e-mail 412 and knows that the two programs are predicted as ones to be recorded. The user “taro” can thus select one of the programs.

Upon receiving an e-mail (413 in FIG. 9) to select the program “2” from the user “taro”, the home network server 101 generates a command to give an instruction to program the electronic device to record the program “2” and sends it to the DVHS 102. The DVHS 102 performs a programming process in response to the command and returns performance result information indicative of the contents of the programming process to the home network server 101.

The home network server 101 prepares a reply e-mail (414 in FIG. 9) with a message including the performance result information from the DVHS 102 and sends it to the sender address “taro@abc-net.co.jp”.

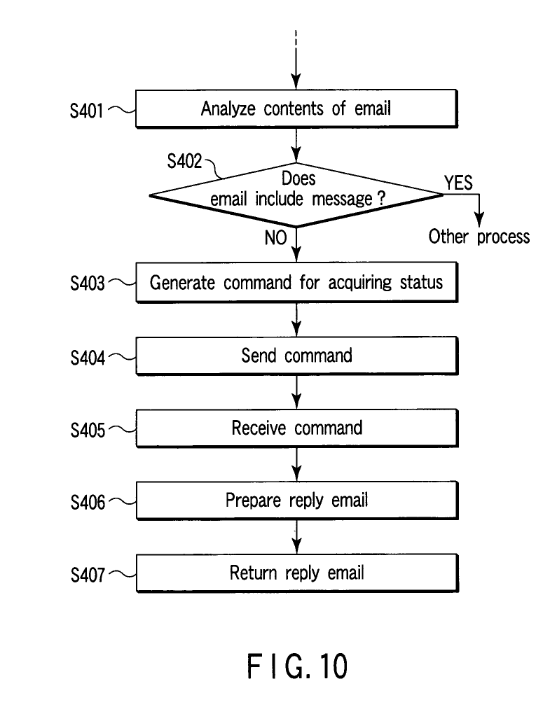

A process that is to be performed by the home network server 101 when the received e-mail has no message to give an instruction will now be described with reference to the flowchart shown in FIG. 10.

The home network server 101 analyzes the contents of the received e-mail to determine whether the body of the e-mail has a message (steps S401 and S402). If the body has a message (YES in step S402), the home network server 101 extracts a keyword, searches a database, and the like in order to check the contents of the instruction.

On the other hand, if the body of the e-mail has no message (NO in step S402), the home network server 101 determines that the e-mail has an instruction to request the acquisition of the status. Then, the server 101 generates a command to acquire the current status of an electronic device designated by the destination address of the received e-mail from the electronic device itself, and sends the status acquiring command to the electronic device (steps S403 and S404).

The electronic device that has received the command sends status information indicative of the current operating status of the device to the home network server 101. Upon receiving the status information from the electronic device (step S405), the home network server 101 creates a reply e-mail with a message including the received status information and sends it back to the user who sent the e-mail (steps S406 and S407).

Assume now that the user “taro” confirms the status of the DVHS 102 away from home.

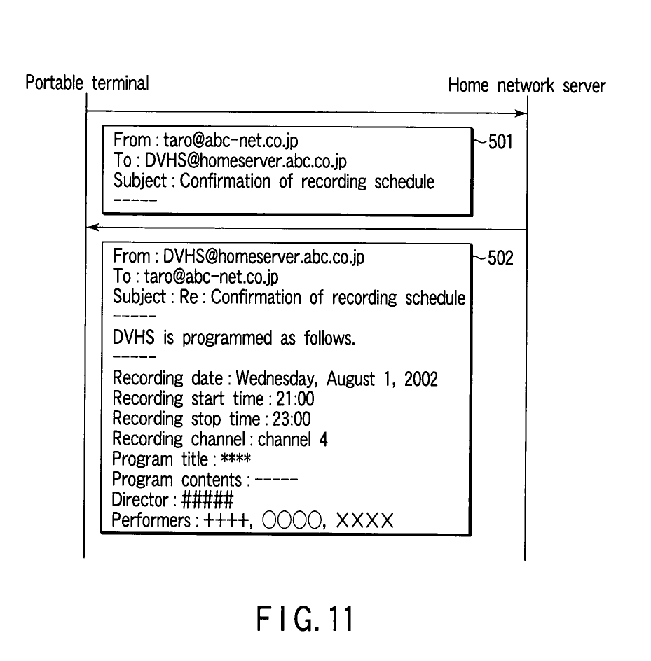

The user “taro” operates the portable terminal 109 to create an e-mail 501 as shown in FIG. 11. The body of the e-mail 501 has no message. The sender address of the e-mail 501 is “taro@abc-net.co.jp” and the destination address thereof is “DVHS@homeserver.abc.co.jp”.

Upon receipt of the e-mail 501, the home network server 101 generates a command to acquire the current recording programming status from the DVHS 102 designated by the destination address “DVHS@homeserver.abc.co.jp” and sends it to the DVHS 102. The DVHS 102 sends a list of the current recording programming statuses to the home network server 101. The server 101 prepares a reply e-mail (502 in FIG. 11) with a message including the list and sends it to the sender address “taro@abc-net.co.jp”.

If, therefore, the user simply sends an e-mail to a target electronic device, he or she can confirm and know the current status of the electronic device.

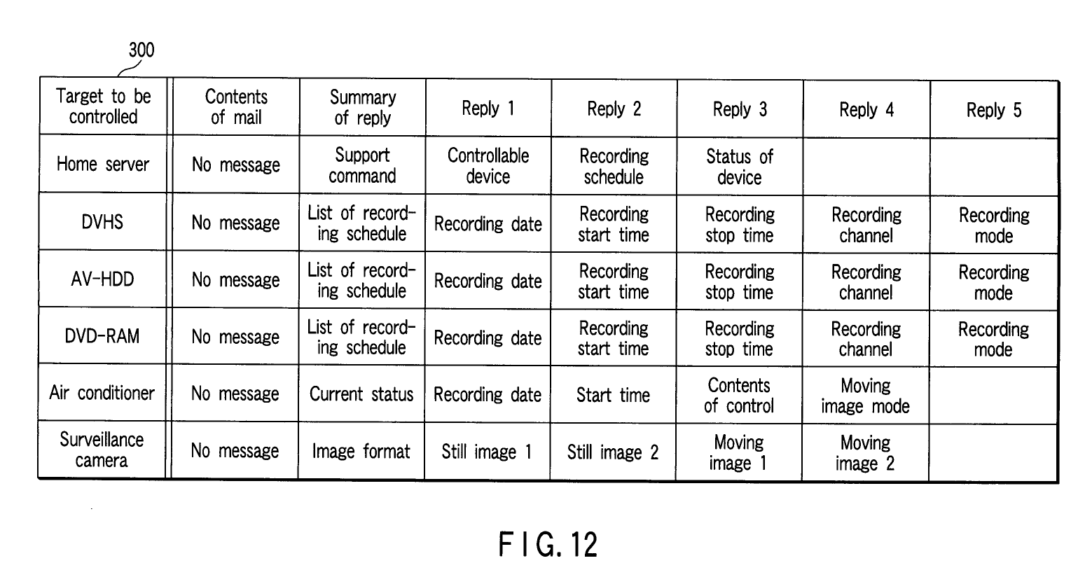

If command definition information 300 as shown in FIG. 12 is stored in the home network server 101, an operation to be performed when an e-mail with no message is received can be defined for each electronic device within the home network system 100.

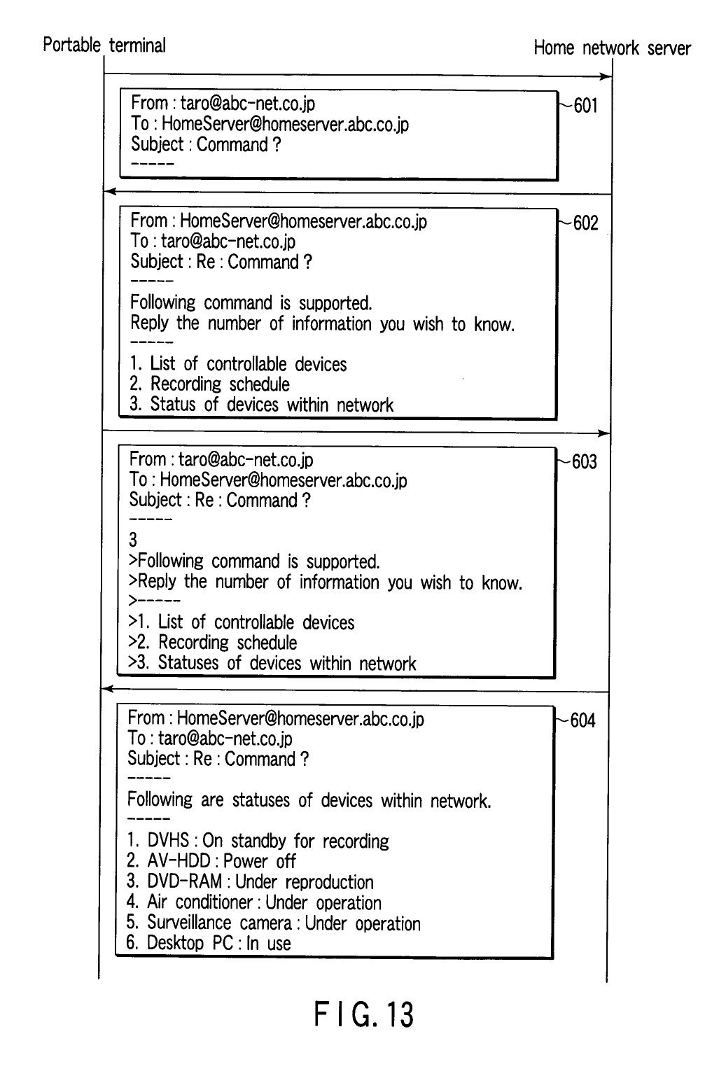

A third example of the process of the transmission/reception of e-mail between the portable terminal 109 and the home network server 101 will now be described with reference to FIG. 13. This example is directed to the case where a user sends an e-mail with no message to the home network server 101.

The user “taro” operates the portable terminal 109 to create an e-mail 601 as shown in FIG. 13. The body of the e-mail 601 includes no message.

The sender address of the e-mail 601 is “taro@abc-net.co.jp” and the destination address thereof is “HomeServer@homeserver.abc.co.jp”.

Upon receiving the e-mail 601, the home network server 101 refers to the command definition information 300 and determines that the function to be performed by the server 101 itself is one that presents a “support command”. This function is used to present a user with a list of functions supported by the home network server 101.

The home network server 101 prepares a reply e-mail (602 in FIG. 13) with a message showing the list of functions supported by the server 101 and sends it to the sender address “taro@abc-net.co.jp”. The net work server 101 supports the following functions:

(1) List of controllable devices: This is a function of presenting a user with a list of electronic devices that can be controlled by e-mail.

(2) Recording programming information: This is a function of presenting a user with a list of the current recording programming statuses of each electronic device having a recording function.

(3) Status of device within network: This is a function of presenting a user with the current status of each electronic device within the home network system 100.

The user “taro” can select one of the above three functions. If the user “taro” returns an e-mail (603 in FIG. 13) for selecting the function (3) to the home network server 101, the server 101 sends a command to each electronic device to acquire the current status of the electronic device from the electronic device. Then, the home network server 101 creates a reply e-mail (604 in FIG. 13) with a message including a list of the statuses of each electronic device and sends it to the sender address “taro@abc-net.co.jp”.

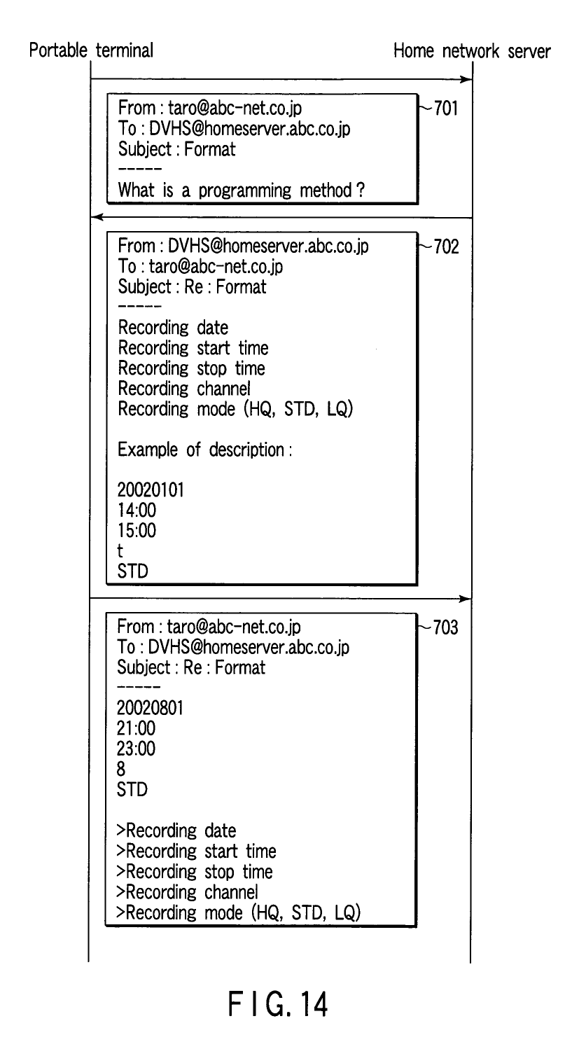

A fourth example of the process of the transmission/reception of e-mail between the portable terminal 109 and the home network server 101 will now be described with reference to FIG. 14. This example is directed to the case where a user is presented with a method of operating an electronic device in the home network system 100, which is inquired by e-mail from the user. Assume that the user “taro” inquires a method of programming the DVHS 102 to perform a recording operation.

The user “taro” operates the portable terminal 109 to create an e-mail 701 as shown in FIG. 14. The body of the e-mail 701 includes a message “What is a programming method?”

The sender address of the e-mail 701 is “taro@abc-net.co.jp” and the destination address thereof is “DVHS@homeserver.abc.co.jp”.

The home network server 101 receives the e-mail 701. From both the destination address “DVHS@homeserver.abc.co.jp” of the e-mail 701 and the message “Recording programming method?” in the e-mail 701, the server 101 recognizes that a method of programming the DVHS 102 has been inquired.

The home network server 101 prepares a reply e-mail (702 in FIG. 14) with a message showing a method of programming the DVHS 102 and send it to the sender address “taro@abc-net.co.jp”.

The user “taro” sees the message of the e-mail 702 to know the method of programming the DVHS 102. The user “taro” operates the portable terminal 109 to make a reply e-mail 703, as shown in FIG. 14, which contains a message showing recording programming information and send it to the destination address “DVHS@homeserver.abc.co.jp”.

The home network server 101 generates a command to program the DVHS 102 based on the programming recording information in the e-mail 703 and sends it to the DVHS 102.

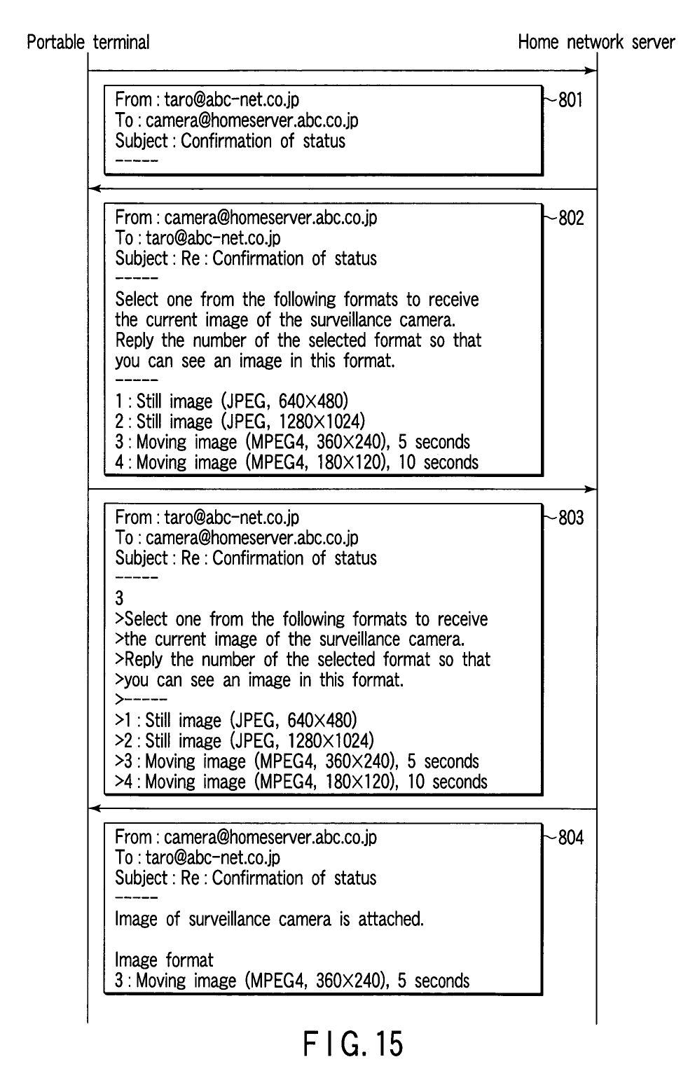

A fifth example of the process of the transmission/reception of e-mail between the portable terminal 109 and the home network server 101 will now be described with reference to FIG. 15. This example is directed to the case where a user sends an e-mail with no message to the surveillance camera 106.

The user “taro” operates the portable terminal 109 to make an e-mail 801 as shown in FIG. 15. The body of the e-mail 801 has no message. The sender address of the e-mail 801 is “taro@abc-net.co.jp” and the destination address thereof is “camera@homeserver.abc.co.jp”.

Upon receiving the e-mail 801, the home network server 101 refers to the command definition information 300 and determines a process to be performed using the surveillance camera 106.

Assume here that a process of inquiring of a user what image format (resolution, still image/moving image) should be used to send an image picked up by the surveillance camera 106 is defined in the command definition information 300.

The home network server 101 prepares a reply e-mail (802 in FIG. 15) with a message showing a list of usable image formats and sends it to the sender address “taro@abc-net.co.jp”. The usable image formats are as follows:

(1) Still image (640×480 pixels)

(2) Still image (1280×1024 pixels)

(3) Moving image (360×480 pixels, 5 seconds)

(4) Moving image (180×120 pixels, 10 seconds)

The user “taro” can select one of the above four image formats. If the user “taro” returns an e-mail (803 in FIG. 15) for selecting the image format (3) to the home network server 101, the server 101 sends a command to request a moving image corresponding to the image format (3) to the surveillance camera 106. The camera 106 picks up an image and sends the moving image corresponding to the image format “3” to the home network server 101.

The home network server 101 prepares a reply e-mail (804 in FIG. 15) with a file of the moving image corresponding to the image format (3) and sends it to the sender address “taro@abc-net.co.jp”.

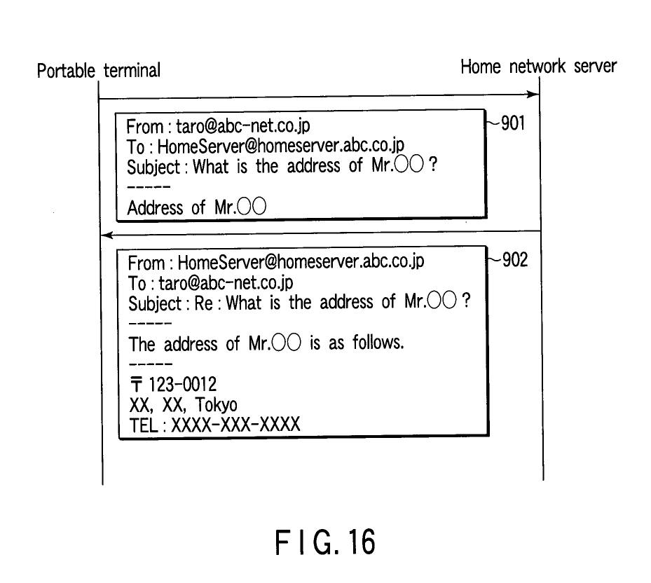

A sixth example of the process of the transmission/reception of e-mail between the portable terminal 109 and the home network server 101 will now be described with reference to FIG. 16. This example is directed to the case where a user is presented with the address of a specific person, which is inquired by e-mail from the user. Assume that an address database is included in the internal database 107 or external database 111.

The user “taro” operates the portable terminal 109 to create an e-mail 901 as shown in FIG. 16. The body of the e-mail 901 includes a message “What is the address of Mr. ∘∘”.

The sender address of the e-mail 901 is “taro@abc-net.co.jp” and the destination address thereof is “HomeServer@homeserver.abc.co.jp”.

Upon receiving the e-mail 901, the home network server 101 analyzes the message “address of Mr. ∘∘” and creates a phrase for searching the address database and acquires address information of Mr. ∘∘ from the address database. The home network server 101 makes a reply e-mail (902 in FIG. 16) with a message including the acquired address information and sends it to the sender address “taro@abc-net.co.jp”.

In the foregoing second to sixth examples, no mention is made of any access control process; however, the access control process in steps S102 and S103 in the flowchart shown in FIG. 7 can be carried out. The type of database is only one; however, a database is prepared in accordance with the destination mail address of an electronic device and a database to be searched can be changed in accordance with the address of e-mail.

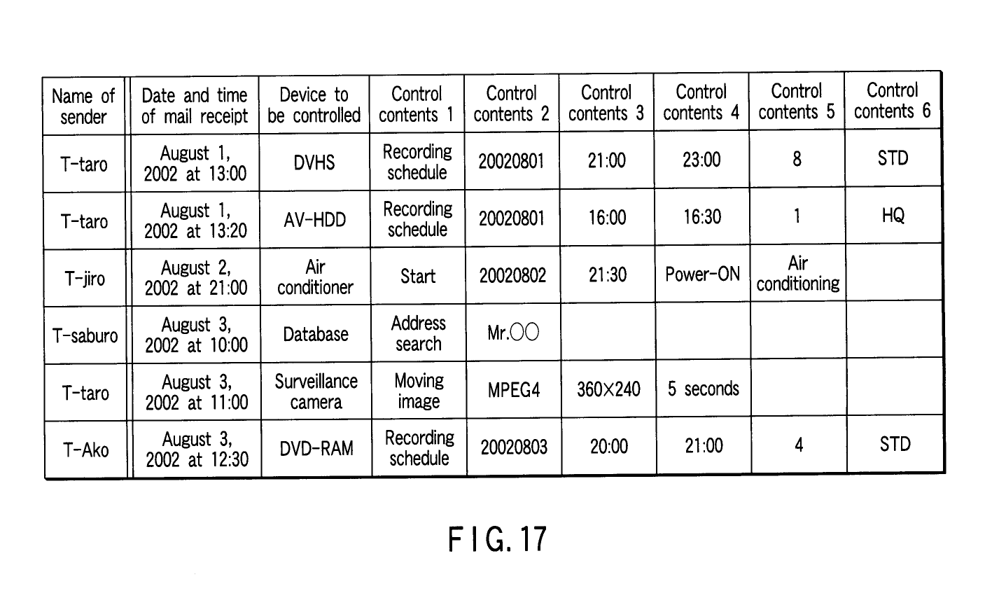

The home network server 101 can manage execution history information of remote control using e-mail. One example of the execution history information is shown in FIG. 17. Referring to FIG. 17, the home network server 101 stores information of the sender of e-mail, the time at which the e-mail is received, the device to be controlled, the contents of control, and the like.

As described above, the present invention has the advantage that a device to be controlled can be specified without any message to designate the device in the body of e-mail since an e-mail address is assigned to each of devices within the home network system 100. The present invention also has the following advantages.

Since the access control that allows or inhibits the execution of remote control in accordance with a combination of the sender address and destination address of e-mail is used, the apparatus is improved in security more than using the access control that is performed only by the sender address of e-mail.

Since an electronic device to be controlled can be specified by the e-mail address, an ID proper to each electronic device such as an IP address set in the electronic device is not exposed to outside. Therefore, the apparatus is improved in security. When unauthorized access is gained to an electronic device, the e-mail address of the electronic device can be changed to thereby prevent the unauthorized access afterward.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A control apparatus which controls first and second electronic devices, comprising:
means for assigning first and second electronic mail addresses to the first and second electronic devices, respectively;
a receiving unit which receives an electronic mail via a network, the electronic mail including one of the first and second electronic mail addresses as a destination address;
means for selecting one of the first and second electronic devices in accordance with the destination address of the received electronic mail; and
means for controlling an operation of the selected electronic device based on an instruction described in the received electronic mail.

2. The control apparatus according to claim 1, further comprising:
a storage unit which stores access control information indicating a relationship between an electronic mail address of each user who gains access to the control apparatus and an electronic device that is controllable by the user; and
means for performing an access control process which allows the electronic device selected in accordance with the destination address to be controlled or inhibits the electronic device from being controlled, based on a sender address and the destination address of the received electronic mail and the access control information.

3. The control apparatus according to claim 1, wherein the controlling means includes:
means for generating a command, which is interpreted by the selected electronic device, based on the instruction described in the received electronic mail; and
means for sending the command to the selected electronic device.

4. The control apparatus according to claim 1, wherein the controlling means includes:
means for analyzing a message composed in the received electronic mail to extract a keyword, which is available as the instruction, from the message;
means for generating a command, which is interpreted by the selected electronic device, based on the extracted keyword; and
means for sending the command to the selected electronic device.

5. The control apparatus according to claim 1, wherein the first electronic device is configured to record a broadcast program, and
the controlling means includes:
means for analyzing a message composed in the received electronic mail including the first electronic mail address as a destination address to extract a keyword, which is available as an instruction to show a broadcast program to be recorded, from the message;
means for predicting contents of the instruction based on both the extracted keyword and a database indicating broadcast date and time, a channel number and an attribute of each broadcast program; and
means for controlling a recording operation of the first electronic device based on prediction results.

6. The control apparatus according to claim 1, wherein the controlling means includes:
means for analyzing a message composed in the received electronic mail to predict contents of the instruction described in the received electronic mail;
means for composing a message indicating the predicted contents of the instruction; and
means for returning an electronic mail including the composed message to a sender of the received electronic mail.

7. A method of controlling first and second electronic devices, comprising:
assigning first and second electronic mail addresses to the first and second electronic devices, respectively;
receiving an electronic mail via a network, the electronic mail including one of the first and second electronic mail addresses as a destination address;
selecting an electronic device to be controlled from the first and second electronic devices in accordance with the destination address of the received electronic mail; and
controlling an operation of the selected electronic device based on an instruction described in the received electronic mail.

8. The method according to claim 7, further comprising:
generating access control information indicating a relationship between an electronic mail address of each user who gains access to a control apparatus, which controls the first and second electronic devices, via the network and an electronic device that is controllable by the user; and
performing an access control process which allows the electronic device selected in accordance with the destination address to be controlled or inhibits the electronic device from being controlled, based on a sender address and the destination address of the received electronic mail and the access control information.

9. The method according to claim 7, wherein the controlling includes:
generating a command, which is interpreted by the selected electronic device, based on the instruction described in the received electronic mail; and
sending the command to the selected electronic device.

10. The method according to claim 7, wherein the controlling includes:
analyzing a message composed in the received electronic mail to extract a keyword, which is available as the instruction, from the message;
generating a command, which is interpreted by the selected electronic device, based on the extracted keyword; and
sending the command to the selected electronic device.

11. The method according to claim 7, wherein the first electronic device is configured to record a broadcast program, and
the controlling includes:
analyzing a message composed in the received electronic mail including the first electronic mail address as a destination address to extract a keyword, which is available as an instruction to show a broadcast program to be recorded, from the message;
predicting contents of the instruction based on both the extracted keyword and a database indicating broadcast date and time, a channel number and an attribute of each broadcast program; and
controlling a recording operation of the first electronic device based on prediction results.

12. The method according to claim 7, wherein the controlling includes:
analyzing a message composed in the received electronic mail to predict contents of the instruction described in the received electronic mail;
composing a message indicating the predicted contents of the instruction; and
returning an electronic mail including the composed message to a sender of the received electronic mail.
